(19) United States
(12) Patent Application Publication
(10) Pub. No.: US 2009/0034274 A1
(43) Pub. Date: Feb. 5, 2009

(54) Electric lamp with an outer bulb and an integral lamp held in a lamp mount and method for its production

(75) Inventor: Roland Stark, Wellheim (DE)

Correspondence Address: FRISHAUF, HOLTZ, GOODMAN & CHICK, PC, 220 Fifth Avenue, 16TH Floor, NEW YORK, NY, 10001-7708, US

(73) Assignee: OSRAM Gesellschaft mit beschrankter, Munchen (DE)

(21) Appl. No.: 12/154,178

(22) Filed: May 21, 2008

(30) Foreign Application Priority Data
Jul. 30, 2007 (DE) 10 2007 035 594.9

(51) Int. Cl. H01J 9/00; H01K 1/50; F21S 13/10

(52) U.S. Cl. 362/363; 313/579; 445/27

(57) ABSTRACT

The invention relates to an electric lamp (1) with a base at one end and with an outer bulb (3), mounted in a base (2), and at least one integral lamp (4), preferably a high-voltage halogen lamp, which is held within the outer bulb (3) by means of a lamp mount (5). The lamp mount (5) and the outer bulb (3) are connected by means of an adhesive joint. The invention likewise relates to a method for producing such a lamp.

### TECHNICAL FIELD

The invention relates to an electric lamp with a base at one end and with an outer bulb, mounted in a base, and at least one integral lamp, preferably a high-volt halogen lamp, which is held within the outer bulb by means of a lamp mount. The invention furthermore relates to a method for producing an electric lamp with a base at one end and with an outer bulb, mounted in a base, and at least one integral lamp, preferably a high-volt halogen lamp, which is held within the outer bulb by means of a lamp mount.

### PRIOR ART

As a result of their long life and pleasant light quality, halogen incandescent lamps are increasingly preferred to conventional incandescent lamps. In order to make it possible to replace existing incandescent lamps with halogen incandescent lamps as simply as possible and at the same time to maintain the visual appearance of a conventional incandescent lamp for aesthetic or functional reasons, lamps are often used in which the outer contour and therefore in particular the outer bulb and the base correspond to a conventional incandescent lamp, while a halogen incandescent lamp is arranged as an integral lamp within the outer bulb. Such lamps are produced and marketed, for example, by OSRAM GmbH under the designation “HALOLUX® CLASSIC”.

In order to bring the outward appearance and the luminous properties of such a lamp close to those of a conventional incandescent lamp, the incandescent wire of the integral lamp needs to be arranged approximately at the same point as the incandescent wire of a comparable conventional incandescent lamp. For this purpose, the substantially more compact halogen lamp needs to be positioned in the outer bulb by means of a holder.

It is known from EP 0 498 256 to fix the integral lamp directly to the power supply lines and therefore to use them as the holder. However, this is only possible with relatively short power supply lines since otherwise the lamp will be extremely sensitive to vibrations and, in the event of breakage of the outer bulb, the power supply lines conducting mains voltage will be exposed.

A technology used in the abovementioned “HALOLUX® CLASSIC” lamps for positioning the integral lamp consists in providing a vitreous plate-like stand, which is fused into the outer bulb. The plate-like stand bears a frame manufactured from metal by means of which the halogen integral lamp is in turn held. Furthermore, power supply lines are fused into the plate-like stand, and the power supply lines of the integral lamp are welded to said power supply lines. This design requires, in order to pass the power supply lines through the vitreous plate-like stand, a three-part design of the power supply lines and is generally very complex as a result of the combination of metallic and vitreous components.

DE 10 2005 051 076 has disclosed a lamp mount for the integral lamp, which lamp mount substantially comprises a metallic mounting clip, into which the integral lamp is inserted and which is pushed onto the vitreous stand, and is fixed via holding knobs before the vitreous stand is fused to the outer bulb. In this case, there is the risk of damage to the glass parts coming into contact with the metallic mounting clip when the lamp is fitted or operated. Furthermore, this design requires considerable complexity in terms of production since the vitreous stand represents a very complex component which comprises, for example, an exhaust tube and fused-in power supply lines, and connection of the power supply lines which have been fused in in the stand to those of the integral lamp is very difficult with the mounting clip pushed on. Fusing of the vitreous stand to the outer bulb also represents a complex method.

### DESCRIPTION OF THE INVENTION

With respect to the lamp, the invention is therefore based on the object of providing an electric lamp with a base at one end and with an outer bulb, mounted in a base, and at least one integral lamp, preferably a high-volt halogen lamp, which is held within the outer bulb by means of a lamp mount, which lamp can be produced in a robust and simple manner.

With respect to the method for producing a lamp, the invention is furthermore based on the object of providing a method for producing an electric lamp with a base at one end and with an outer bulb, mounted in a base, and at least one integral lamp, preferably a high-volt halogen lamp, which is held within the outer bulb by means of a lamp mount, which method makes it possible to produce such a lamp in a simple manner.

With respect to the lamp, the object is achieved according to the invention by virtue of the fact that the lamp mount and the outer bulb are connected by means of an adhesive joint. An adhesive joint makes it possible to fix the lamp mount to the outer bulb mechanically in a simple manner, it being possible, as a result of the avoidance of direct contact between metal and glass, to markedly reduce the risk of damage. It is possible to dispense with the complex vitreous lamp stand, as a result of which production of the lamp is substantially simplified and accelerated. The complex fusing of the lamp stand with the outer bulb is also dispensed with. In addition, given suitable selection of the adhesive, an adhesive joint can be used to compensate for the different elastic properties of metal and glass.

It is of particular advantage if the adhesive joint comprises thermally curable cement. Such adhesives make it possible to correct the adhesion position up until curing and also otherwise provide simple handling. As a result of the widespread use in lamp construction, units for handling the cement are usually already provided and there is extensive experience in working with the cement. Furthermore, the cement can be cured possibly at the same time as the cement between the outer bulb and the base, with the result that there is no need for an additional working step.

It is particularly expedient if the lamp mount is designed to be cylindrical in the lower region, and the outer diameter of the lamp mount is dimensioned so as to be slightly smaller than the inner diameter of the outer bulb in the base region. Then, only a small interspace between the lamp mount and the outer bulb needs to be overcome by the cement and optimum adhesion is achieved.

Advantageously, the lower region of the lamp mount has at least one depression, preferably at least one peripheral groove and/or channel. In this depression, the cement can be applied without being stripped off when the lamp mount is inserted into the outer bulb. During baking, expanding cement can spread out laterally starting from the depression or groove and fill the interspace between the lamp mount and the outer bulb.

It is expedient if the lamp mount is formed from an aluminum material. Aluminum and alloys based thereon are light, easy to process, resistant to corrosion and have good mechanical properties.

Furthermore, it is advantageous if the lamp mount, in the upper end side, has an opening for accommodating the integral lamp. As a result, the base of the integral lamp can be held in the lamp mount in a simple manner and a particularly compact design of the lamp mount is made possible. The power supply lines from the base to the integral lamp are protected particularly effectively against touching contact involving the risk of electric shock in the event of breakage of the outer bulb.

It is likewise advantageous if the shape of the opening approximately corresponds to the cross section of the base of the integral lamp. As a result, the integral lamp is held particularly effectively and only few additional holding apparatuses are required.

It is likewise expedient if the opening is designed to be approximately rectangular and/or has approximately rectangular sections. Rectangular openings are particularly well suited, for example, for holding bases with a double T shape, as are often used in integral lamps. Differently shaped openings which have rectangular cutouts in which the edges of the integral lamp are held also perform the same function.

In addition, it is advantageous if the lamp mount has at least one holding knob. Holding knobs can be manufactured with little complexity and are particularly well suited for inserting glass components such as the base of the integral lamp into a fixing and holding it there.

Furthermore, it is advantageous if the lamp mount has at least two opposite holding knobs. This facilitates the insertion of the base into the lamp mount and secure holding there.

By virtue of the fact that at least one holding knob acts on the narrow side of the base of the integral lamp, the integral lamp is held particularly effectively. The risk of skewing during insertion of the integral lamp into the lamp mount is particularly high along the narrow sides of the base. By attaching the holding knobs at a point where they act on the narrow side, this risk is markedly reduced.

It is advantageous if the lamp mount is designed to be rectangular in the upper region. A rectangular configuration is particularly advantageous if a rectangular opening is provided. In this case, the upper region can be produced, for example, by rectangular beveling of a metal sheet.

With respect to the method, the object is achieved according to the invention by virtue of the fact that the method comprises the following steps:
a) power supply lines of the integral lamp are connected, preferably welded, to power supply wires,
b) the power supply wires and the integral lamp are inserted into the lamp mount, with the result that the integral lamp is held by the lamp mount,
c) adhesive, preferably thermally curable cement, is applied in the lower region of the lamp mount, in particular into the at least one depression, which is preferably configured as at least one peripheral groove and/or channel,
d) the integral lamp is introduced with the lamp mount into the outer bulb,
e) a power supply line is bent back laterally in such a way that contact with the base sleeve can be produced,
f) the base is applied to the outer bulb and the base and the outer bulb are preferably connected using cement applied to the base,
g) the power supply wires are cut to length and connected to the base, preferably by means of soldering.

This method makes it possible to manufacture a lamp according to the invention in a simple and efficient manner.

It is particularly advantageous if the cement between the lamp mount and the outer bulb is thermally cured between steps d) and e). As a result, the lamp mount is firmly connected to the outer bulb and the two component parts can be handled together.

In a further advantageous design of the invention, the cement between the lamp mount and the outer bulb is thermally cured in the same working step as the cement between the outer bulb and the base. As a result, only one heating process is required in order to cure the two cement joints, which saves on process time and energy.

### BRIEF DESCRIPTION OF THE DRAWINGS

The invention will be explained with reference to four exemplary embodiments below. Identical or functionally identical components are identified by the same reference numerals. In the figures:

FIG. 1 shows a first exemplary embodiment of a lamp according to the invention in a perspective view,

FIG. 2 shows a lamp according to the invention in accordance with the first exemplary embodiment in a lateral illustration of a sectional diagram,

FIG. 3 shows a detail illustration of the lamp mount in accordance with the first exemplary embodiment in a perspective illustration,

FIG. 4 shows a detail illustration of a second exemplary embodiment of a lamp mount according to the invention in a perspective view, and

FIG. 5 shows a detail illustration of a third exemplary embodiment of a lamp mount according to the invention in a perspective view.

### PREFERRED EMBODIMENT OF THE INVENTION

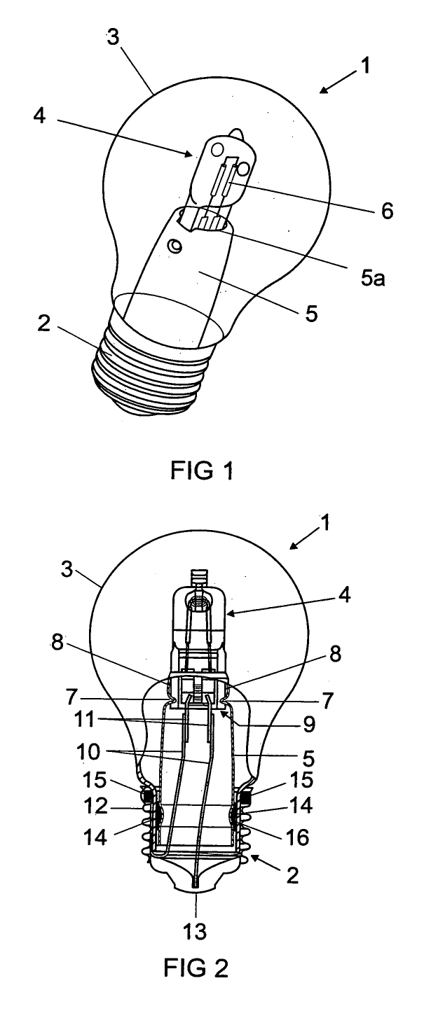

FIG. 1 shows a lamp 1 according to the invention in a perspective illustration. An outer bulb 3 of the type A55 is held in a base 2 of the conventional type E27. An integral lamp 4 is arranged within the outer bulb 3 by means of a lamp mount 5 in such a way that an incandescent wire 6 of the integral lamp 4 is located approximately at the point within the outer bulb 3 at which the incandescent wire is likewise arranged in a conventional incandescent lamp. The integral lamp 4 is configured as a so-called high-volt halogen lamp using pinching technology and is known as such from the prior art. The lamp mount 5 is substantially in the form of a cylindrical component, in the case of which the integral lamp 4 is held in an opening 5a.

FIG. 2 shows the lamp 1 according to the invention in a lateral illustration of a sectional view which illustrates the design principle. The integral lamp 4 is fixed in the lamp mount 5 by means of two holding knobs 7, which act on the narrow sides 8 of the base 9 of the integral lamp 4. In addition, the power supply wires 10, which lead from the base of the lamp 1 to the power supply lines 11 of the integral lamp 4 to which they are welded, are used for securing the integral lamp 4 in the axial direction. At their other end, the power supply wires 10, which are manufactured from a copper/nickel alloy, as is marketed, for example, under the trade name “Monel” by Special Metals Corporation, are passed out of the lamp mount 5 and soldered to a base sleeve 12 of the base 2 and to a bottom contact 13. Contact between the power supply wires 10 and the lamp mount 5 is avoided since, otherwise, the lamp mount 5 would be live, which would be disadvantageous in the event of breakage of the outer bulb 3 as a result of the risk of touching contact with live parts.

The lamp mount 5 is held in the region of the base 2 of the lamp 1 by virtue of the fact that a cement layer 14 is located in accordance with the invention between the outer bulb 3 and the lamp mount 5. The cement is identical in terms of its composition to that of the cement layer 15 between the base sleeve 12 of the lamp 1 and the outer bulb 3. The lamp mount 5 has a peripheral channel 16, into which the cement is introduced before the outer bulb 3 is pushed onto the lamp mount 5. This ensures that a sufficient quantity of cement is applied and is distributed peripherally as a uniform cement layer 14. In particular a situation is avoided in which the cement is shaved off at individual points.

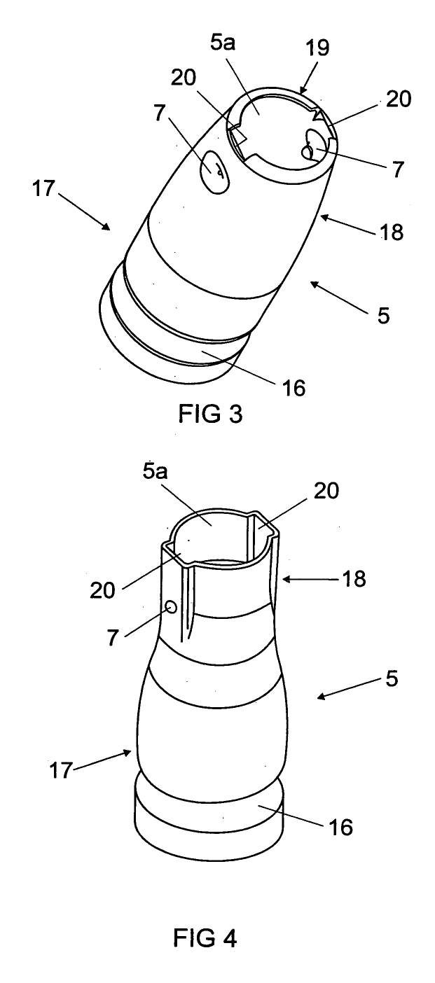

FIG. 3 shows the lamp mount 5 in a perspective illustration. The lamp mount 5 is configured as a deep-drawn component and is manufactured from aluminum with a degree of purity of 99.5%. Aluminum is suitable with this or similar degrees of purity as a result of its good deep-drawing properties particularly for this application, but other materials, in particular also Al alloys, are also conceivable.

In the lower region 17, the lamp mount 5 is cylindrical, the outer diameter being approximately constant over wide areas and, when used in an A55 outer bulb 3, with 19 mm is slightly smaller than the inner diameter of the outer bulb 3, with the result that a gap of approximately 1-1.5 mm between the outer bulb 3 and the lamp mount 5 results. The size of the gap is in this case selected in such a way that, firstly, the cement can spread well therein and, secondly, a firm hold between the outer bulb 3 and the lamp mount 5 is achieved. The peripheral channel 16 is arranged in the lower region. In the upper region 18, the diameter of the lamp mount 5 tapers until the inner diameter approximately corresponds to the width of the base 9 of the integral lamp 4. The opening 5a for accommodating the base 9 of the integral lamp 4 is arranged on the end side 19 of the lamp mount 5. The substantially circular opening 5a has two rectangular cutouts 20, which are arranged above the holding knobs 7. Since conventional integral lamps 4 usually have base cross sections which are rectangular or in the form of a double T, they are guided safely and precisely along their outer edges and the base 9 of the integral lamp 4 is secured against rotation as well as against displacement in the radial direction.

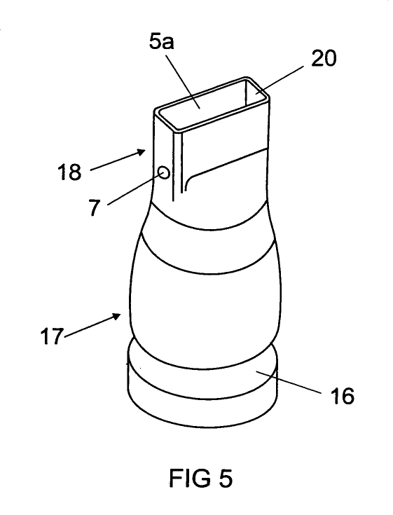

A further embodiment of the lamp mount which differs from the preceding exemplary embodiment primarily by virtue of the design of the upper region 18, is shown in FIG. 4. In the lower region 17, the lamp mount 5 is cylindrical in a similar manner to the first exemplary embodiment with an outer diameter which is approximately constant over wide areas (19 mm when used in an A55 outer bulb 3). Again, the peripheral channel 16 is arranged within this region. In this exemplary embodiment as well, the opening 5a for accommodating the integral lamp 4 has a circular cross section with two diametrically arranged rectangular cutouts 20. In contrast to the first exemplary embodiment, however, the entire upper region 18 as far as the holding knobs 7 is configured such that it has a cross section such that particularly effective linear guidance of the integral lamp 4 is achieved. This shape of the lamp mount 5 can be manufactured in one working step by means of deep-drawing, with the result that, in contrast to the first exemplary embodiment, there is no stamping out of the complicated geometry of the opening 5a. In this case, too, again two holding knobs 7 are provided which secure the integral lamp 4 substantially against axial displacement. In addition, again the power supply wires 10 act as securing means against axial displacement in this case too.

A further exemplary embodiment of a lamp mount according to the invention is shown in a perspective view in FIG. 5. In this case, too, the differences are restricted to the configuration of the upper region 18, which has a rectangular cross section as far as the holding knobs 7. As a result, the integral lamp 4 is likewise guided and held very precisely and at the same time a very simple shape of the lamp mount 5 is achieved which requires little production complexity since a single deep-drawing process with a relatively simple die is sufficient for producing the basic shape into which the holding knobs 7 then merely need to be introduced.

The manufacture of the lamp 1 according to the invention takes place by virtue of the fact that, initially, the power supply wires 10 are welded to the power supply lines 11 of the integral lamp 4, then the power supply lines 11 and the integral lamp 4 are introduced into the opening 5a of the lamp mount 5, onto which cement has already been applied in the lower region 18. Then, the lamp mount 5 is introduced into the outer bulb 3 and the cement is baked. Subsequently, one of the power supply wires 10 is bent back in the form of a U and the base 2 which has already been provided with cement is fixed on the outer bulb 3, whereupon the cement is baked and subsequently the power supply wires 10 are soldered to the base 2. The same cement is used for both cement layers 14, 15. Typically, in this case a cement based on phenol resin is used, but other types are also conceivable. A different adhesive could also be used instead of thermally curable cement. The conditions for curing of the cement are naturally matched to the respectively used cement and are known to a person skilled in the art, for example from the specifications of the cement manufacturer.

Naturally, variants of this production process are also possible. For example, the application of the cement onto the lamp mount 5 can also take place, for example, only once the integral lamp 4 has been introduced into the lamp mount 5. It is also conceivable, given suitable temperature control, for the curing of the cement between the lamp mount 5 and the outer bulb 3 and between the outer bulb 3 and the base 2 to take place in one working step.

In terms of the embodiment of the lamp 1 itself, further variants are of course also conceivable. For example, in particular the configuration of the lamp mount 5 and in this case primarily in the upper region 18 in which the integral lamp 4 is held, can deviate considerably from the exemplary embodiments shown. For example, the holding knobs 7 could also act on the longitudinal sides of the base 9 of the integral lamp 4. Instead of or in addition to the holding knobs 7, in addition spring tongues are also conceivable, for example. In terms of the material used for the lamp mount 5 as well, other materials are also conceivable instead of the aluminum used, for example alloys based on other metals, ceramic or organic materials.

Instead of the outer bulb 3 with the designation A55 which is shown in the exemplary embodiments and is typical for a general-service incandescent lamp, other bulb shapes, such as types A60, R63, R80 or G95, for example, are naturally also conceivable, and other base sizes such as E14 or E40, and other base types such as bayonet-type bases or plug-type bases, for example, are also possible instead of the screw-type base shown of the type E27.

1. An electric lamp (1) with a base at one end and with an outer bulb (3), mounted in a base (2), and at least one integral lamp (4), preferably a high-volt halogen lamp, which is held within the outer bulb (3) by means of a lamp mount (5), characterized in that the lamp mount (5) and the outer bulb (3) are connected by means of an adhesive joint.

2. The electric lamp (1) with a base at one end as claimed in claim 1, characterized in that the adhesive joint comprises thermally curable cement.

3. The electric lamp (1) with a base at one end as claimed in claim 1, characterized in that the lamp mount (5) is designed to be cylindrical in the lower region (17), and the outer diameter of the lamp mount (5) is dimensioned so as to be slightly smaller than the inner diameter of the outer bulb (3) in the base region.

4. The electric lamp (1) with a base at one end as claimed in claim 1, characterized in that the lower region (17) of the lamp mount (5) has at least one depression (16), preferably at least one peripheral groove and/or channel (16).

5. The electric lamp (1) with a base at one end as claimed in claim 1, characterized in that the lamp mount (5) is formed from an aluminum material.

6. The electric lamp (1) with a base at one end as claimed in claim 1, characterized in that the lamp mount (5), in the upper end side (19), has an opening (5a) for accommodating the integral lamp (4).

7. The electric lamp (1) with a base at one end as claimed in claim 6, characterized in that the shape of the opening (5a) approximately corresponds to the cross section of the base (9) of the integral lamp (4).

8. The electric lamp (1) with a base at one end as claimed in one of claims 5 to 7, characterized in that the opening (5a) is designed to be approximately rectangular and/or has approximately rectangular sections (20).

9. The electric lamp (1) with a base at one end as claimed in claim 1, characterized in that the lamp mount (5) has at least one holding knob (7).

10. The electric lamp (1) with a base at one end as claimed in claim 1, characterized in that the lamp mount (5) has at least two opposite holding knobs (7).

11. The electric lamp (1) with a base at one end as claimed in either of claims 9 and 10, characterized in that at least one holding knob (7) acts on the narrow side (8) of the base (9) of the integral lamp (4).

12. The electric lamp (1) with a base at one end as claimed in claim 1, characterized in that the lamp mount (5) is designed to be rectangular in the upper region (18).

13. A method for producing an electric lamp (1) with a base at one end and with an outer bulb (3), mounted in a base (2), and at least one integral lamp (4), preferably a high-volt halogen lamp, which is held within the outer bulb (3) by means of a lamp mount, characterized by the following steps:
a) power supply lines (11) of the integral lamp (4) are connected, preferably welded, to power supply wires (10),
b) the power supply wires (10) and the integral lamp (4) are inserted into the lamp mount (5), with the result that the integral lamp (4) is held by the lamp mount (5),
c) adhesive, preferably thermally curable cement, is applied in the lower region (17) of the lamp mount (5), in particular into the at least one depression (16), which is preferably configured as at least one peripheral groove and/or channel (16),
d) the integral lamp (4) is introduced with the lamp mount (5) into the outer bulb (3),
e) a power supply wire (10) is bent back laterally in such a way that contact with the base sleeve (12) can be produced,
f) the base (2) is applied to the outer bulb (3) and the base (2) and the outer bulb (3) are preferably connected using cement applied to the base (2),
g) the power supply wires (10) are cut to length and connected to the base (2), preferably by means of soldering.

14. The method as claimed in claim 13, characterized in that the cement between the lamp mount (5) and the outer bulb (3) is thermally cured between steps d) and e).

15. The method as claimed in claim 13, characterized in that the cement between the lamp mount (5) and the outer bulb (3) is thermally cured in the same working step as the cement between the outer bulb (3) and the base (2).

16. The electric lamp (1) with a base at one end as claimed in claim 1, characterized in that
the adhesive joint comprises thermally curable cement;
the lamp mount (5) is designed to be cylindrical in the lower region (17), and the outer diameter of the lamp mount (5) is dimensioned so as to be slightly smaller than the inner diameter of the outer bulb (3) in the base region;
the lower region (17) of the lamp mount (5) has at least one depression (16), preferably at least one peripheral groove and/or channel (16);
the lamp mount (5) is formed from an aluminum material;
the lamp mount (5), in the upper end side (19), has an opening (5a) for accommodating the integral lamp (4);
the shape of the opening (5a) approximately corresponds to the cross section of the base (9) of the integral lamp (4);
the opening (5a) is designed to be approximately rectangular and/or has approximately rectangular sections (20);
the lamp mount (5) has at least one holding knob (7);
at least one holding knob (7) acts on the narrow side (8) of the base (9) of the integral lamp (4); and
the lamp mount (5) is designed to be rectangular in the upper region (18).
